(19) United States
(12) Patent Application Publication
(10) Pub. No.: US 2026/0077983 A1
(43) Pub. Date: Mar. 19, 2026

(54) INDUSTRIAL TRUCK

(71) Applicant: Palfinger AG, Bergheim bei Salzburg (AT)

(72) Inventor: Mario HASLAUER, Bergheim bei Salzburg (AT)

(21) Appl. No.: 19/322,093

(22) Filed: Sep. 8, 2025

(30) Foreign Application Priority Data
Sep. 13, 2024 (AT) GM 50121/2024

(51) Int. Cl. B66F 9/075; B60Q 1/34; B60Q 5/00

(52) U.S. Cl. CPC B66F 9/07504; B60Q 1/346; B60Q 5/005; B60Q 2800/20

(57) ABSTRACT

An industrial truck includes a height-adjustable load-handling device, a motor, at least three wheels, at least one of the three wheels to be driven by the motor, a warning system for delivering warning signals to the surroundings, and a switching device. The warning system can be automatically activated by selecting a predetermined direction of travel of the industrial truck, and the industrial truck has at least two warning systems for delivering warning signals to the surroundings. The at least two warning systems each can be automatically activated by selecting a predetermined direction of travel of the industrial truck, and at least one of the warning systems is configured to deliver acoustic warning signals and at least one of the warning systems is configured to deliver visual warning signals. The switching device is configured to selectively activate any one of the at least two warning systems.

### BACKGROUND OF THE INVENTION

The disclosure relates to an industrial truck having a warning system.

Warning systems for such industrial trucks for delivering warning signals to the surrounding area, especially for personal protection, are known in two different variants: those that deliver an acoustic warning signal such as a beeping or hissing sound (see DE 10 2022 133 140 A1) and those that deliver a visual warning signal such as a light signal projected onto the ground (see DE 10 2012 024 494 A1, DE 10 2006 002 960 A1 and EP 2 700 612 A1).

Both solutions have their advantages and disadvantages in different surroundings, wherein the warning system delivering visual warning signals is particularly suitable in areas with high noise pollution or in areas where noise pollution is not permitted.

### SUMMARY OF THE INVENTION

The task is to provide an industrial truck that combines the advantages of both warning systems in terms of the warning function.

Such an industrial truck has at least:
one height-adjustable load-handling device,
one motor,
three wheels, at least one of which can be driven by the motor,
two warning systems for delivering warning signals to the surroundings, wherein the at least two warning systems are each automatically activated by selecting a predetermined direction of travel of the industrial truck, at least one of the at least two warning systems is designed to deliver acoustic warning signals and at least one of the at least two warning systems is designed to deliver visual warning signals, and
a switching device by means of which one of the at least two warning systems each can be selectively activated.

Such an industrial truck can accommodate different areas of application by having two different warning systems and by selectively activating one of the warning systems without losing the advantage of the other warning system. This is particularly advantageous for stackers, especially truck-mounted forklifts, as they can be used in very different surroundings.

In one embodiment, the switching device can be operated by an operator, preferably the driver, of the industrial truck (e.g., a manually operated switch with two switch positions). This allows the operator, preferably the driver, to decide for themselves which of the at least two warning systems should be used in the current situation.

In a very noisy environment or in a quiet environment (e.g., at night), using the warning system that delivers visual warning signals will be advantageous. In any case, the warning system delivering acoustic warning signals can also be selected by the operator, preferably the driver.

Alternatively or additionally, the switching device could be designed automatically to activate the selective activation or at least to display a selection proposal to the operator, preferably the driver, e.g., depending on the surrounding situation. For example, the brightness could be detected (e.g., by a twilight sensor) and/or the presence of surrounding noise above a predetermined volume could be detected and/or a specific time could be detected, e.g., during a predetermined period of time at night, and the warning system delivering visual warning signals could automatically be selected and activated by the switching device, or a proposal for selecting this warning system could at least be displayed to the operator, preferably the driver. It can be provided that the operator, preferably the driver, has a right to veto in case of an automatic selection.

In one embodiment, at least one travel direction of the at least one predetermined travel direction, in which the at least two warning systems are each automatically activated, is a reverse travel direction.

The wheels can contact the ground either directly or via a track.

If one of the at least two warning systems is selected, automatic activation can be carried out as described in the prior art, e.g., by a pressure switch which is supplied with the on-board voltage of the industrial truck and is actuated by pressing the direction pedal, so that the electrical voltage is switched to the selected warning system. In other advantageous embodiments, the direction pedal can be implemented by another actuation, for example a button.

A visual signal can, for example, comprise an image projected onto the ground.

### BRIEF DESCRIPTION OF THE DRAWINGS

The invention will be discussed in more detail below with reference to the drawings, in which:

FIG. 1 is a perspective view of an industrial truck in the form of a truck-mounted forklift, and

FIG. 2 is a schematic representation of FIG. 1.

### DETAILED DESCRIPTION OF THE INVENTION

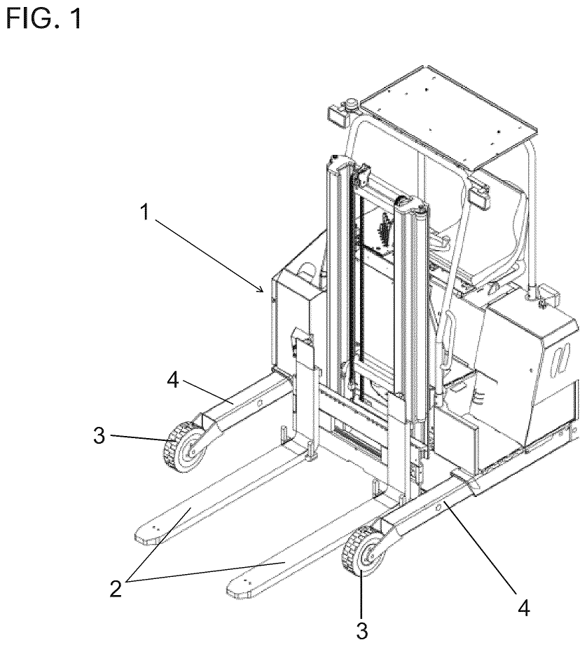

The industrial truck 1 shown in FIG. 1 and designed as a truck-mounted forklift 7 has the following features in a known manner:
a load-handling device 2 that can be raised and lowered
at least three wheels 3, with which the truck-mounted forklift 7 can be moved on a surface, wherein at least one wheel 3 of the at least three wheels 3 can be driven by a motor and, by way of example, at least two wheels 3 are arranged on a telescopic arm 4 that can be extended and retracted
a motor 5 for driving the at least one drivable wheel 3
a motor control 6 for actuating the motor 5, taking into account the operating commands of a driver of the truck-mounted forklift

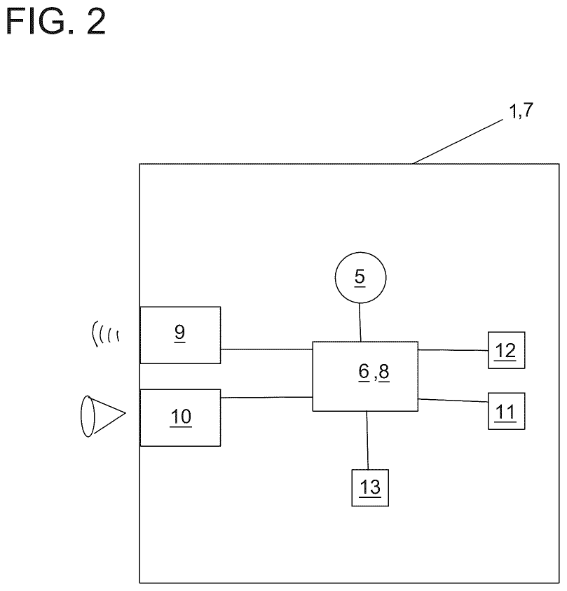

As shown in FIG. 2, the industrial truck 1 has at least two warning systems 9, 10 for delivering warning signals to the surroundings, wherein the at least two warning systems 9, 10 can each automatically be activated by selecting at least one predetermined direction of travel of the industrial truck 1. A direction of travel can be selected by a driver using a direction of travel selection switch 13.

At least one of the at least two warning systems 9, 10 is designed to deliver acoustic warning signals. Another of the at least two warning systems 9, 10 is designed to deliver visual warning signals.

A switching device 8 is provided (here, as an example, implemented in the motor control 6), by means of which one of the at least two warning systems 9, 10 can be selectively activated. This can be done by a switch 12 to be operated by the driver and/or automatically depending on the signals from a measuring device 11 for automatically determining surrounding conditions and/or a time.

### REFERENCES

1 industrial truck
2 load handling device, for example a fork
3 wheel
4 telescopic arm
5 motor
6 motor control
7 truck-mounted forklift
8 switching device
9 warning system for delivering acoustic warning signals
10 warning system for delivering visual warning signals
11 measuring device for automatically determining surrounding conditions and/or a time
12 switch
13 selecting switch for direction of travel

1. An industrial truck comprising:
a height-adjustable load handling device,
a motor,
at least three wheels, at least one of the at least three wheels to be driven by the motor,
a warning system for delivering warning signals to the surroundings, wherein the warning system can be automatically activated by selecting at least one predetermined direction of travel of the industrial truck, and
a switching device,
wherein the industrial truck has at least two warning systems for delivering warning signals to the surroundings, wherein the at least two warning systems can each be automatically activated by selecting at least one predetermined direction of travel of the industrial truck,
wherein at least one of the at least two warning systems is designed to deliver acoustic warning signals and at least one of the at least two warning systems is designed to deliver visual warning signals, and
wherein the switching device is configured to selectively activate any one of the at least two warning systems.

2. The industrial truck according to claim 1, wherein the switching device is configured to be operated by an operator, preferably the driver, of the industrial truck.

3. The industrial truck according to claim 1, wherein the switching device is configured to automatically perform the selective activation or at least to display a selection proposal for the operator, preferably the driver, wherein it is particularly preferred that the operator has a right to veto.

4. The industrial truck according to claim 1, wherein at least one direction of travel of the at least one predetermined direction of travel, in which the at least two warning systems each are automatically activated, is a reverse travel direction.

5. The industrial truck according to claim 1, wherein the at least one pre-selected warning system switches to the at least one other warning system by actuation of the switching device.

6. The industrial truck according to claim 1, wherein the industrial truck is designed as a stacker, preferably as a truck-mounted forklift.
